(19) United States
(12) Patent Application Publication
(10) Pub. No.: US 2003/0158973 A1
(43) Pub. Date: Aug. 21, 2003

(54) Program for CD-R/RW writing, operation control program and drive apparatus

(75) Inventor: Seiji Tsukada, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 10/338,739

(22) Filed: Jan. 9, 2003

(30) Foreign Application Priority Data
Feb. 19, 2002 (JP) P 2002-041631

(51) Int. Cl. G06F 13/10; G06F 9/00

(52) U.S. Cl. 709/327; 709/321; 713/1

(57) ABSTRACT

When a CPU does not perform retrieval in S22 yet on that day (decision of YES in S20), the CPU checks a type of a CD-R/RW drive connected and a version of firmware (S21), and makes connection to a site of a maker of the drive (S22), and compares a version uploaded thereto with a version checked in S21 (S23). When the version uploaded is newer, the contents in which version up is performed are displayed (S24) and a user is made to input whether or not to perform version up of firmware (S25). Then, on condition that performance of the version up is inputted (decision of YES in S26), the version up of firmware is performed (S27).

### BACKGROUND OF THE INVENTION

The present invention relates to a program for CD-R/RW writing, an operation control program and a drive apparatus, and particularly to a program for CD-R/RW writing, an operation control program and a drive apparatus in which a computer automatically executes updating of firmware of a device connected to the computer through a network.

Conventionally, in an apparatus providing a communication function, a technique for performing version up of firmware of a device connected to the apparatus through a network is proposed.

For example, a technique about updating (version up) of firmware of a communication device is disclosed in a publication of the Unexamined Japanese Patent Application Publication No. Heill-215245. Specifically, in the case of version up, first, information as to whether or not the version up of firmware is necessary is originated from the communication device to a management server through a communication line. Then, when the management server decides that the version up is necessary, the firmware is transferred to the communication device. Incidentally, the contents to the effect that the communication device originates the information as to whether or not the version up is necessary every time a constant period elapses are also disclosed in the same publication.

Further, a technique in which updating of firmware of an external device connected to an apparatus such as a computer or a communication apparatus is enabled at the time of powering on the apparatus is disclosed in the Unexamined Japanese Patent Application Publication No.2001-109703. Specifically, at the time of powering on the computer or the communication apparatus, the apparatus makes checks of a state of its inside and a state of the external device and initialization, and thereafter acquires the newest program from a predetermined site through a network, and updates the firmware of the external device.

As described above, by performing updating of the firmware of the device through the network, the updating is performed easily at low cost.

However, in most cases, the updating of the firmware becomes a plus in the device or the apparatus connected to the device, but there are very rare cases that the updating does not become a plus. For example, in the case that the apparatus connected to the device is difficult to cope with new firmware, it is considered that trouble occurs between the apparatus and the device when the firmware is updated.

Then, in the conventional techniques, the updating of the firmware was performed easily, but it was difficult to avoid the trouble as described above.

### SUMMARY OF THE INVENTION

The invention is contrived in view of such circumstances, and an object of the invention is to provide a program for CD-R/RW writing, an operation control program and a drive apparatus capable of easily performing updating of firmware and avoiding the updating in the case that the updating of the firmware is unnecessary.

A program for CD-R/RW writing according to one aspect of the invention is a program for CD-R/RW writing for executing writing on a CD-R/RW in an apparatus for CD-R/RW writing connected to a computer, and is characterized in that the computer is made to execute the steps of deciding whether or not a calendar of a day is updated, deciding whether or not said computer retrieves information inside a management server for managing information about firmware of the apparatus for CD-R/RW writing on that day in the case of starting said program for CD-R/RW writing, detecting a version of the firmware of the apparatus for CD-R/RW writing on condition that information inside the management server is not retrieved on that day, retrieving firmware of a version newer than the version of the firmware of the apparatus for CD-R/RW writing from information inside the management server for managing information about firmware of the apparatus for CD-R/RW writing, presenting the contents in which version up is performed with respect to the firmware of the apparatus for CD-R/RW writing of the detected version of said new firmware in the case of finding the firmware of the new version, presenting information for promoting an input of information as to whether or not to update the firmware of the apparatus for CD-R/RW writing in the case of finding the firmware of the new version, and downloading the firmware of the new version from the management server and updating the firmware of the apparatus for CD-R/RW writing on condition that information to the effect that the firmware of the apparatus for CD-R/RW writing is updated is inputted.

According to one aspect of the invention, a user of a computer can control whether or not the computer is made to perform version up of firmware in the case that firmware of an apparatus for CD-R/RW writing of a new version resides in a management server. Incidentally, the contents in which version up is performed with respect to firmware mounted in the apparatus for CD-R/RW writing currently are presented in firmware of the new version, so that the user can decide whether or not the computer is made to perform version up of firmware based on the contents in which the version up is performed. Further, the contents in which the version up is performed are presented on condition that the computer is not retrieved the management server on that day in the case of starting software for CD-R/RW writing.

As a result of this, since the new version of firmware is first retrieved by the computer, updating of the firmware is performed easily and in addition, the user can control whether or not to perform updating of the firmware with respect to the computer, so that the updating of the firmware can be avoided when the user decides that the updating of the firmware is unnecessary. Further, the user can decide whether or not the updating of the firmware is necessary based on the contents in which version up is performed in firmware of the new version. Further, retrieval, which is a step for updating of the firmware, of the management server is performed only once per day in the case of starting software for CD-R/RW writing, so that the step is not too large and is performed only a proper number of times with respect to use of the apparatus for CD-R/RW writing of the user. Further, information for promoting an input of information as to whether or not to perform updating of the firmware is presented, so that the user can easily understand that the input of information to that effect is necessary to perform the updating of the firmware.

An operation control program according to another aspect of the invention is a program for controlling an operation of a device connected to a computer, and is characterized in that the computer is made to execute the steps of deciding whether or not a calendar of a day is updated, detecting a version of firmware of the device, retrieving firmware of a version newer than the version of the firmware of the device from information inside a management server for managing information about the firmware of the device, and downloading the firmware of the new version from the management server and updating the firmware of the device on condition that information to the effect that updating of the firmware of the device is performed is inputted.

According to another aspect of the invention, a user of a computer can control whether or not the computer is made to perform version up of firmware in the case that firmware of a new version of a device resides in a management server.

As a result of this, since the new version of firmware is first retrieved by the computer, updating of the firmware is performed easily and in addition, the user can control whether or not to perform updating of the firmware with respect to the computer, so that the updating of the firmware can be avoided when the user decides that the updating of the firmware is unnecessary.

Further, in an operation control program of the invention, the step of retrieving the firmware of the new version is preferably executed on condition that a program for making it an essential condition of operating the device is started in the computer.

As a result of this, retrieval, which is a step for updating of the firmware, of the management server is performed only a proper number of times according to use of the device of the user.

Further, in an operation control program of the invention, the computer is preferably made to further execute a step of deciding whether or not the step of retrieving the firmware of the new version from information inside the management server is performed on that day, and execute the step of retrieving the firmware of the new version from information inside the management server on condition that it is decided that said step is not performed yet on that day.

As a result of this, retrieval, which is a step for updating of the firmware, of the management server is performed only once per day, so that the number of times of performance of the step is not too large.

Further, in an operation control program of the invention, the computer is preferably made to further execute a step of presenting the contents in which version up is performed with respect to the retrieved firmware of the device of the firmware of the new version.

As a result of this, the user can decide whether or not the updating of the firmware is necessary based on the contents in which version up is performed in firmware of the new version.

Further, in an operation control program of the invention, the computer is preferably made to further execute a step of presenting information for promoting an input of information as to whether or not to perform updating of the firmware of the device in the case of finding the firm wareof the new version.

As a result of this, the user can easily understand that the input of information to that effect is necessary to perform the updating of the firmware.

A drive apparatus according to a further aspect of the invention is characterized by executing the program for CD-R/RW writing according to one aspect of the invention described above.

A drive apparatus according to another aspect of the invention is characterized by executing the operation control program according to another aspect of the invention described above.

### BRIEF DESCRIPTION OF THE DRAWINGS

FIG. 1 is a diagram schematically showing a configuration of a network system including computers (clients) for executing a program which is one embodiment of the invention;

FIG. 2 is a block diagram of the client of FIG. 1;

FIG. 3 is a flowchart of CD-R/RW writing processing executed in the client of FIG. 1; and

FIG. 4 is a flowchart of a subroutine of firmware version up processing of FIG. 3.

### DETAILED DESCRIPTION OF THE PREFERRED EMBODIMENTS

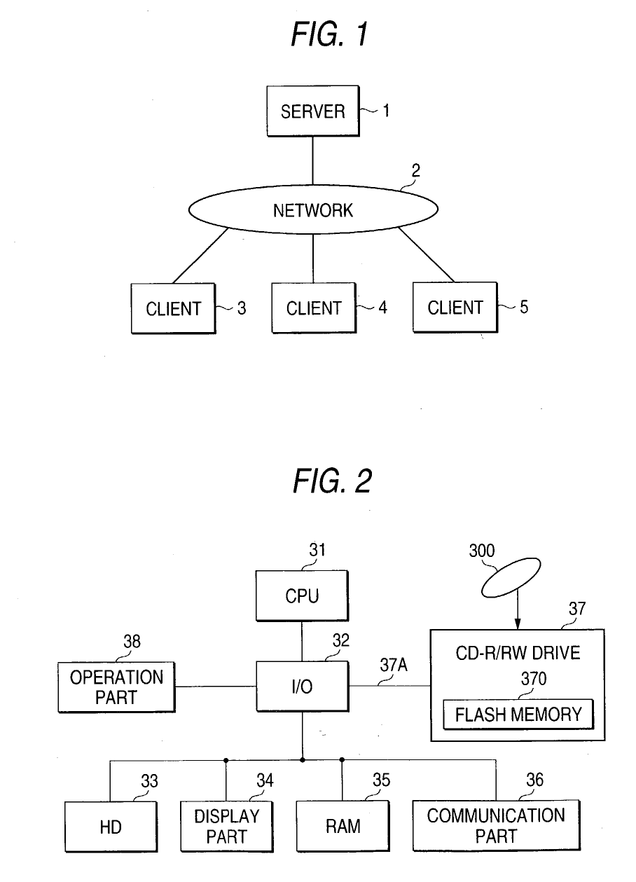

FIG. 1 is a diagram schematically showing a configuration of a network system including computers (clients) for executing a program which is one embodiment of the invention. In this system, a server 1 is connected to clients 3 to 5 through a network 2. The network 2 may be a public telephone line or a LAN (local area network). The server 1 stores information about a site of a maker of a CD-R/RW drive 37 (see FIG. 2) mounted in the client 3. Incidentally, the newest version of firmware of the CD-R/RW drive 37 can be downloaded from the site.

Next, a configuration of the client 3 will be described with reference to FIG. 2. Incidentally, the clients 3 to 5 have similar configurations.

The client 3 comprises a CPU 31 for controlling the entire operation of the client 3, a HD 33 for storing various information including files and operation programs of the CPU 31, a display part 34 formed of a liquid crystal display, RAM 35 acting as a work area of the CPU 31, a communication part 36 for sending and receiving data with other apparatus through the network 2, a CD-R/RW drive 37 capable of reading information stored in a record medium 300 such as a CD-R, CD-RW (Compact Disk ReWritable) inserted from the outside and rewriting information about the record medium 300, and an operation part 38 such as a keyboard in which a user inputs information. The CPU 31 is connected to the HD 33, the display part 34, the RAM 35, the communication part 36, the CD-R/RW drive 37 and the operation part 38 through an input/output interface (I/O) 32. The CD-R/RW drive 37 comprises flash memory 370 for storing firmware, and is connected to the input/output interface 32 through an interface cable 37A.

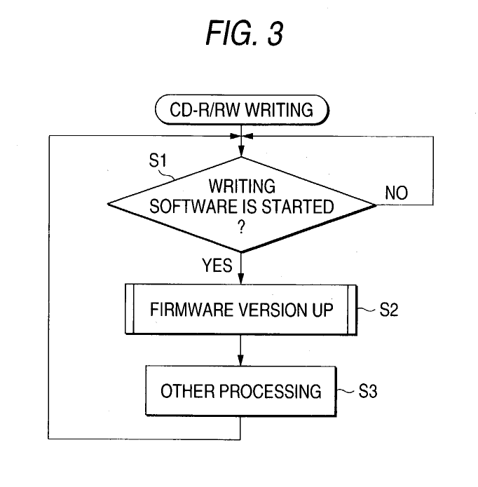

FIG. 3 is a flowchart of CD-R/RW writing processing executed in the case of starting software for CD writing in the client 3. Software for CD-R/RW writing is a program started in the case of writing information on a record medium in the CD-R/RW drive 37, and is one example of a program for CD-R/RW writing.

When the software is started (YES in S1), the CPU 31 performs processing for performing version up of firmware of the CD-R/RW drive 37 in S2. Then, other processing, namely various processing such as writing of information on the CD-R or CD-RW in the CD-R/RW drive 37 is performed in S3.

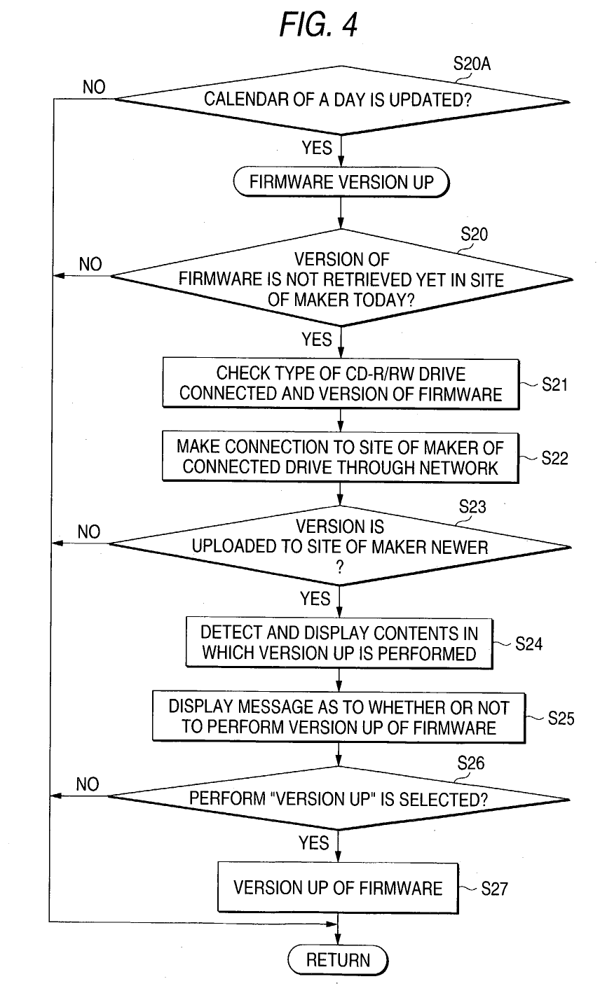

FIG. 4 is a flowchart of a subroutine of firmware version up processing in S2 of FIG. 3.

In the firmware version up processing, first, the CPU 31 decides whether a version of firmware in a site (present within the server 1 in the embodiment) of a maker of the CD-R/RW drive 37 in S22 described below is not retrieved yet on that day in S20. Then, when it is already retrieved on that day, the processing returns as it is. On the other hand, when it is not retrieved yet on that day, the processing is advanced to S21.

In S21, the CPU 31 communicates with a CD-R/RW drive (CD-R/RW drive 37) connected, and checks a type of the CD-R/RW drive 37 and a version of firmware.

Then, in S22, connection to a site of a maker of the CD-R/RW drive 37 is made through the network 2 and a version of firmware of the same type as that of the CD-R/RW drive 37 uploaded to the site is retrieved.

Then, in S23, a version of firmware of the same type as that of the CD-R/RW drive 37 uploaded to the site is compared with a version of firmware of the CD-R/RW drive 37 checked in S21 and it is decided whether or not the version uploaded to the site is newer. If it is decided that the version uploaded to the site is newer, the processing is advanced to S24 and if not, it returns as it is.

In S24, the contents in which version up is performed are detected and the contents are displayed on the display part 34 and then, in S25, a message for inputting whether or not to perform version up of firmware with respect to a user is displayed on the display part 34. Based on this display, the user inputs information as to whether or not to perform version up using the operation part 38.

Then, in S26, it is decided whether or not information inputted from the user is information that “performs version up”. Then, when it is information that “performs version up”, the processing is advanced to S27. On the other hand, when it is information that “does not perform version up”, it returns as it is.

In S27, version up of firmware is performed and it returns. The version up of firmware specifically means that firmware of a new version is downloaded and firmware stored in the flash memory 370 of the CD-R/RW drive 37 is rewritten.

In the embodiment described above, a device or an apparatus for CD-R/RW writing targeted for version up of firmware is formed by the CD-R/RW drive 37. Incidentally, the invention is not limited to the CD-R/RW drive as the device targeted for version up of firmware, and can be applied to any devices as long as there are devices which can be connected to a communicable apparatus and provide firmware, for example, a CD-R drive, a CD-ROM (compact disc read only memory) drive, a printer and a modem.

Further, in the embodiment, a program for making it an essential condition of operating a device is formed by software for CD-R/RW writing.

Incidentally, the firmware version up processing shown in FIG. 4 is performed in the case of starting a program for making it an essential condition of operating a device in the client 3, but timing of performing the processing is not limited to this. For example, it may be performed in the case of starting a program for controlling a general operation of a certain device (OS (operating system) of a computer to which the device is connected).

It should be considered that the embodiment disclosed this time is illustrative at all points and is not limitative. The scope of the invention is shown by claims rather than the description and it is intended that all changes within the meaning and the scope of the claims and the equivalent are included.

Besides, date updating function is built in a computer.

In the invention described above, a user of a computer can control whether or not the computer is made to perform version up of firmware in the case that firmware of a new version resides in a management server with respect to a device such as an apparatus for CD-R/RW writing connected to the computer. Incidentally, the contents in which version up is performed with respect to firmware mounted in the device currently are presented in firmware of the new version, so that the user can decide whether or not the computer is made to perform version up of firmware based on the contents in which the version up is performed. Further, the contents in which the version up is performed are presented on condition that the computer does not retrieve the management server on that day in the case of starting software for CD-R/RW writing.

Therefore, according to the invention, since the new version of firmware is first retrieved by the computer, updating of the firmware is performed easily and in addition, the user can control whether or not to perform updating of the firmware with respect to the computer, so that the updating of the firmware can be avoided when the user decides that the updating of the firmware is unnecessary. Further, the user can decide whether or not the updating of the firmware is necessary based on the contents in which version up is performed in firmware of the new version. Further, retrieval, which is a step for updating of the firmware, of the management server is performed only once per day in the case of starting a program requiring an operation of the device (for example, software for CD-R/RW writing), so that the step is not too large and is performed only a proper number of times with respect to use of the apparatus for CD-R/RW writing of the user. Further, information for promoting an input of information as to whether or not to perform updating of the firmware is presented, so that the user can easily understand that the input of information to that effect is necessary to perform the updating of the firmware.

What is claimed is:

1. A program for CD-R/RW writing for executing writing on a CD-R (Compact Disc Recordable)/RW (ReWritable) in an apparatus for CD-R/RW writing connected to a computer,
said program comprising the steps of:
deciding whether or not a calendar of a day is updated,
deciding whether or not said computer retrieves information inside a management server for managing information about firmware of the apparatus for CD-R/RW writing on that day in the case of starting said program for CD-R/RW writing,
detecting a version of the firmware of said apparatus for CD-R/RW writing on condition that information inside said management server is not retrieved on that day, retrieving firmware of a version newer than the version of the firmware of said apparatus for CD-R/RW writing from information inside said management server for managing information about firmware of said apparatus for CD-R/RW writing,
presenting the contents in which version up is performed with respect to the firmware of said apparatus for CD-R/RW writing of the detected version of said new firmware in the case of finding the firmware of the new version,
presenting information for promoting an input of information as to whether or not to update the firmware of said apparatus for CD-R/RW writing-in the case of finding the firmware of the new version, and
downloading the firmware of the new version from said management server and updating the firmware of said apparatus for CD-R/RW writing on condition that information to the effect that the firmware of said apparatus for CD-R/RW writing is updated is inputted.

2. An operation control program for controlling an operation of a device connected to a computer,
said program comprising the steps of:
deciding whether or not a calendar of a day is updated,
detecting a version of firmware of said device,
retrieving firmware of a version newer than the version of the firmware of said device from information inside a management server for managing information about the firmware of said device, and
downloading the firmware of the new version from said management server and updating the firmware of said device on condition that information to the effect that updating of the firmware of said device is performed is inputted.

3. The operation control program as defined in claim 2, wherein
a step of retrieving the firmware of the new version is executed on condition that a program for making said device operate be an essential condition is started in said computer.

4. The operation control program as defined in claim 2, further comprising the steps of:
deciding whether or not the step of retrieving the firmware of the new version from information inside said management server is performed on that day, and
retrieving the firmware of the new version from information inside said management server on condition that it is decided that said step is not performed yet on that day.

5. The operation control program as in claim 2, further comprising:
a step of presenting the contents in which version up is performed with respect to the retrieved firmware of said device of the firmware of the new version.

6. The operation control program as in claim 2, further comprising:
a step of presenting information for promoting an input of information as to whether or not to perform updating of the firmware of said device in the case of finding the firmware of the new version.

7. The drive apparatus for executing a program for CD-R/RW writing as defined in claim 1.

8. The drive apparatus for executing an operation control program as defined in claim 2.
